(19) United States
(12) Patent Application Publication
(10) Pub. No.: US 2016/0115971 A1
(43) Pub. Date: Apr. 28, 2016

(54) DIFFUSER PIPE WITH SPLITTER VANE

(71) Applicant: PRATT & WHITNEY CANADA CORP., Longueuil (CA)

(72) Inventors: Hien DUONG, Mississauga (CA); Vijay KANDASAMY, Tamil Nadu (IN)

(21) Appl. No.: 14/524,004

(22) Filed: Oct. 27, 2014

(51) Int. Cl. F04D 29/54; B23P 15/00

(52) U.S. Cl. CPC F04D 29/547; B23P 15/00

(57) ABSTRACT

A compressor diffuser for a gas turbine engine includes a plurality of diffuser pipes each having a diverging tubular body defining a flow passage extending fully therethrough. The tubular body includes a first portion extending in a first direction, a second portion extending in a second direction different from the first direction, and a curved portion interconnecting the first portion and the second portion. At least one splitter vane extends into the flow passage and disposed at least partially within the curved portion of the tubular body.

### TECHNICAL FIELD

The application relates generally to gas turbine engines and, more particularly, to compressor diffusers therefor.

### BACKGROUND

Diffuser pipes are provided in gas turbine engines for directing flow of compressed air from a centrifugal compressor to an annular chamber containing the combustor, while diffusing the high speed air. The diffuser pipes are typically circumferentially arranged at a periphery of an impeller, and are designed to transform kinetic energy of the flow into pressure energy. Diffuser pipes may provide a uniform exit flow with minimal distortion, as it is preferable for flame stability, low combustor loss, reduced hot spots etc. While longer diffuser pipes may accomplish better diffusion, spatial constraints in the gas turbine engine may restrict their length. Large flow diffusion in diffuser pipes over insufficient pipe length may result in thick and weak boundary layers built up on the pipe wall. To compensate for a shorter length, many diffuser pipes have a tight bend. Turbulence and other non-streamline behavior of the flow at the bend may lead to pressure losses and decrease efficiency of the diffuser pipe.

### SUMMARY

In one aspect, there is provided a compressor diffuser for a gas turbine engine, the diffuser having a plurality of diffuser pipes each comprising: a diverging tubular body defining a flow passage extending fully therethrough, the tubular body including a first portion extending in a first direction, a second portion extending in a second direction different from the first direction, and a curved portion interconnecting the first portion and the second portion; and at least one splitter vane extending into the flow passage and disposed at least partially within the curved portion of the tubular body.

In another aspect, there is provided a gas turbine engine comprising a centrifugal compressor including an impeller case and a plurality of diffuser pipes downstream of the impeller and receiving compressed air therefrom, each of the diffuser pipes having a diverging tubular body defining a flow passage extending therethrough, the tubular body of the diffuser pipes extending from the periphery of the impeller case and including a radial portion and an axial portion connected by a curved portion, the curved portion having at least one splitter vane disposed at least partially within the flow passage.

In a further aspect, there is provided a method of manufacturing a diffuser pipe for a centrifugal compressor of a gas turbine engine, the method comprising: forming a tubular body out of a sheet metal, the tubular body having a first portion extending in a first direction, a second portion extending in a second direction different from the first direction, and a curved portion between the first portion and the second portion; inserting a splitter vane at least partially into the curved portion of the tubular body and aligning sides of the splitter vane in a desired position between opposed walls of the curved portion; and fixing the sides of the splitter vane to the opposed walls within the curved portion.

### DESCRIPTION OF THE DRAWINGS

Reference is now made to the accompanying figures in which:

FIG. 1 is a schematic cross-sectional view of a gas turbine engine;

FIG. 2 is a schematic perspective view of an impeller and corresponding plurality of radially disposed diffuser pipes;

FIG. 3 is a schematic perspective view of one of the diffuser pipes having a splitter vane;

FIG. 4 is a schematic cross-sectional view of the diffuser pipe of FIG. 3;

FIG. 5 is another schematic cross-sectional view (partial) of the diffuser pipe of FIG. 3;

FIG. 6 is a schematic side elevation view another diffuser pipe having two splitter vanes, and shown with shading to illustrate streamline of the flow having various velocities; and

FIG. 7 is a schematic top view of the diffuser pipe of FIG. 6.

### DETAILED DESCRIPTION

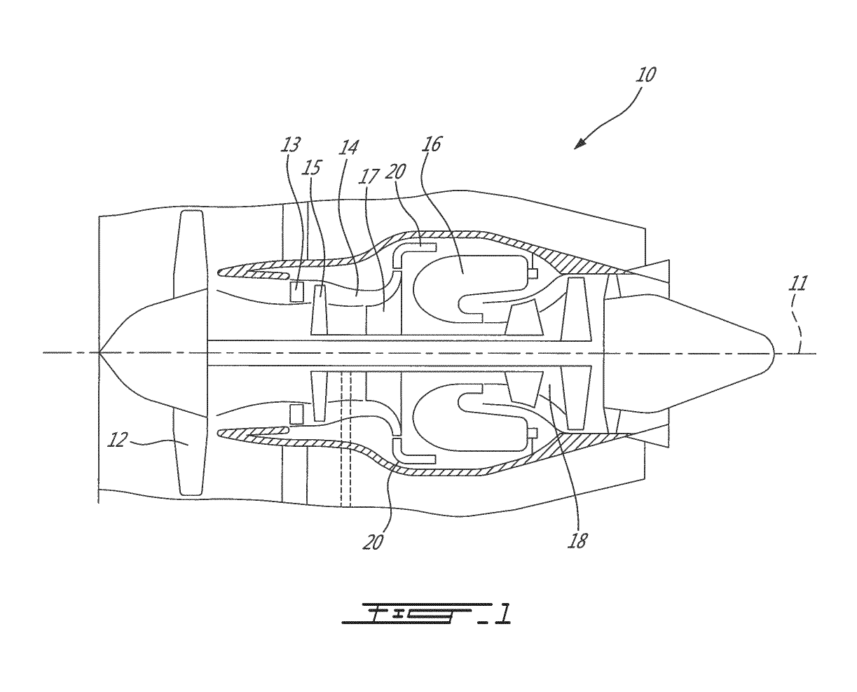

FIG. 1 illustrates a gas turbine engine 10 of a type preferably provided for use in subsonic flight, generally comprising in serial flow communication along an engine axis 11: a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The compressor section 14 includes a plurality of stators 13 and rotors 15 (only one stator 13 and rotor 15 being shown in FIG. 1), and an impeller 17. A plurality of diffuser pipes 20 are circumferentially disposed at a periphery of the impeller 17 and redirect the exhaust gases from a radial orientation to an axial orientation (i.e. aligned with the engine axis 11). Diffusers, such as the diffuser pipes 20, convert high kinetic energy at impeller 17 exit to static pressure by slowing down fluid flow. In most cases, a Mach number of the flow entering the diffuser pipe 20 may be at or near sonic, while a Mach number exiting the diffuser pipe 20 may be in the range of 0.2-0.25 to enable stable air/fuel mixing, light/re-light in the combustor 16.

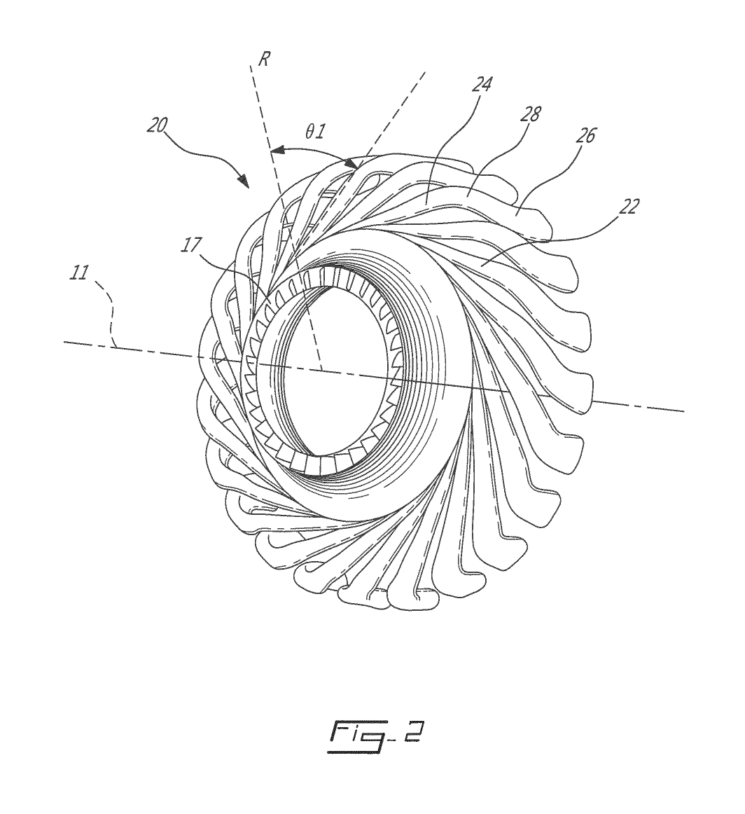

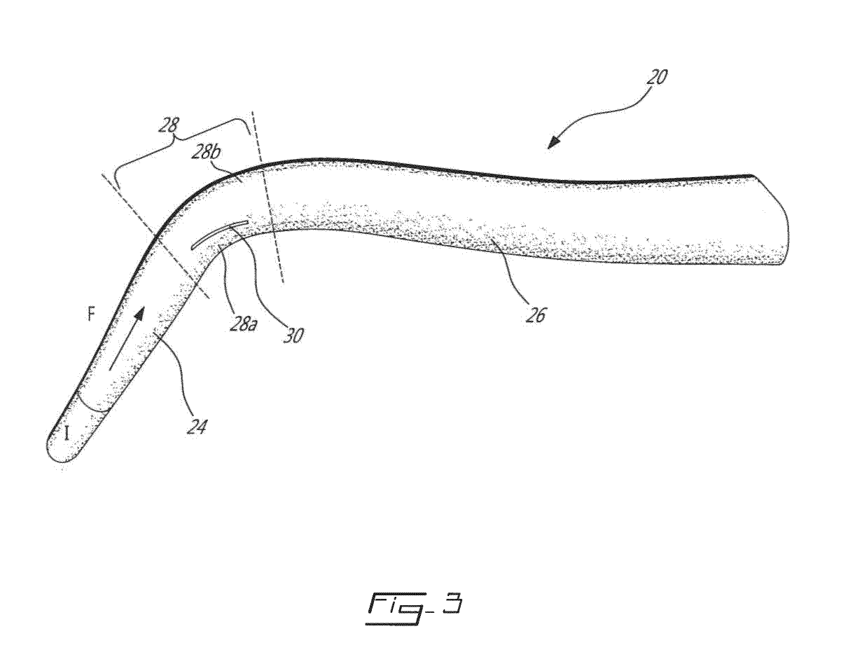

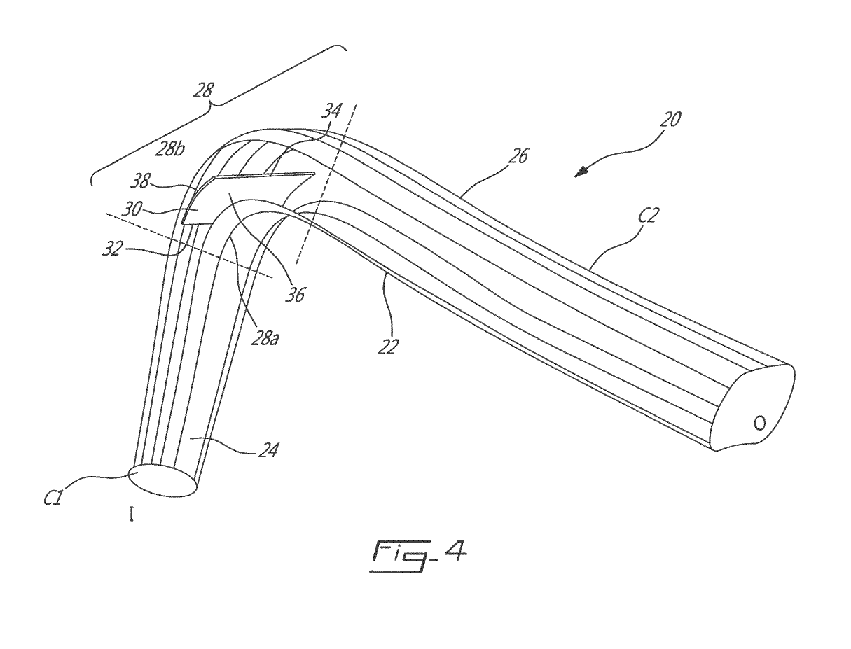

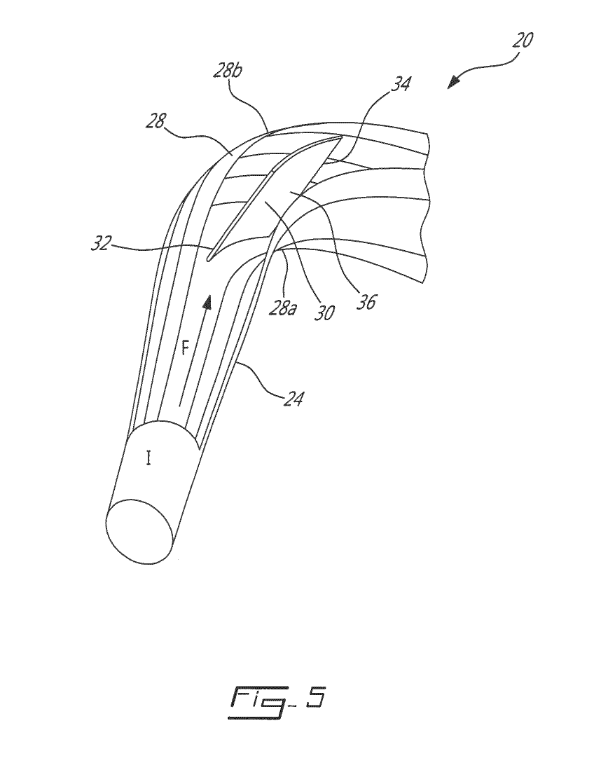

Turning now to FIG. 2, a front perspective view of the impeller 17 shows the plurality of diffuser pipes 20, commonly known as “fishtail diffuser pipes”. Each of the diffuser pipes 20 includes a tubular body 22, formed, in one embodiment, of sheet metal. The body 22 includes a first portion 24 extending generally tangentially from the periphery of the impeller 17. The first portion 24 has an open end forming an inlet I (shown in FIG. 4) of the diffuser pipe 20. The first portion 24 is inclined at an angle θ1 relative to a radial axis R. The angle θ1 may be at least partially tangential, or even substantially tangentially, and may further correspond to a direction of airflow at the exit of the blades of the impeller 17, to facilitate transition of the flow F (shown in FIG. 3) from the impeller 17 to the diffuser pipes 20. The first portion 24 could alternatively extend more substantially along the radial axis R.

A second portion 26 is disposed generally axially and is connected to the first portion 24 by an out-of-plane bend or curved portion 28. The second portion 26 includes an open end forming an outlet O (shown in FIG. 4) of the diffuser pipe 20.

High swirl of the flow F exiting the impeller 17, and therefore entering the first portion 24 of each of the diffuser pipes 20, may be removed by shaping the diffuser pipe 20 with the curved portion 28, such that the flow F is redirected axially before existing to the combustor 16. For a given impeller exit Mach number and swirl of the flow F, the effectiveness of a diffuser pipe may be dependent upon its length. For a fishtail pipe type diffuser, such as the one described herein, the greater the length the easier it is for the pipe to diffuse flow efficiently without, or with minimal, flow separation at the curved portion 28. Length can be obtained by growing pipe radially or axially or both. Longer diffuser pipes are however disadvantaged in that they can potentially increase both weight and size of the engine. In addition, a required gap between the outlet and fuel nozzle locations is another constraint that put a physical limit on radial/axial extension of the diffuser pipes 20. As a result, the diffuser pipe 20 may be designed to have a tight 90 degrees bend to compensate for a reduced length.

In the depicted embodiment, the cross-sectional area of the diffuser pipe 20 increases gradually and continuously along its length, from the inlet I to the outlet O. The first portion 24 has a generally circular cross-section C1 (shown in FIG. 4), while the second portion 26 has generally a flattened oval (or oblong) cross-section C2 (shown in FIG. 4). Other types of cross-sections for the first portion 24 and the second portion 26 are contemplated.

Referring now to FIGS. 3 to 5, each of the diffuser pipes 20 includes within its interior passage a guide or splitter vane 30, disposed between inner wall 28a and outer wall 28b of the diffuser pipe 20. In the present embodiment, the splitter vane 30 is disposed within the interior passage at the curved or bent portion 28 of the pipe. The curved portion 28 may be defined by a zone of redirection between the first portion 24 and the second portion 26, as illustrated by the two dotted lines joined by the bracket 28 in FIGS. 3 and 4. It is contemplated that the splitter vane 30 could be only partially disposed in the curved portion 28, and therefore extend at least partially into the first or the second portion 24, 26. However, in one particular contemplated embodiment, a majority of the total length of the splitter vane 30 is disposed within the redirection zone defined at the curved portion 28. The presence of the splitter vane 30 may at least reduce some of the drawbacks associated with the tight bend of the curved portion 28, as noted below.

The curvature of the curved portion 28 may tend to detach the flow F from the walls 28a, 28b, which can result in pressure losses and non-uniform flow at the outlet O. Mixing loss may contribute to overall diffuser performance. Flow separation in the diffuser pipe 20 starting at the curved portion 28 may not only be potentially detrimental to the compressor section 17 performance and operability, but also to its structural integrity as flow separation can be destructive in nature and can lead to premature pipe breakage, fatigue, cracking, noise, flame instability etc.

The diffuser pipe 20 of the present disclosure may relieve the pressure gradient at the curved portion 28 by the presence of the splitter vane 30. While the splitter vane 30 may provide additional aerodynamic friction loss, the reduction in overall mixing loss may more than offset this increase.

As seen in FIG. 4, the splitter vane 30 is, in this embodiment, airfoil shaped and includes a leading edge 32 and a trailing edge 34. The airfoil of the splitter vane 30 therefore defines a pressure side 36 and a suction side 38, as conventionally known for airfoils. The splitter vane 30 is oriented in the diffuser pipe 20 so that the leading edge 32 receives the incoming flow F, and a curvature of the airfoil shaped splitter vane 30 is in a same direction as the curved portion 28 of the diffuser pipe 20. In other words, the pressure side 36 of the airfoil 30 faces the inner wall 28a. The splitter vane 30 is generally disposed to conform to the flow F (i.e. streamlined) so that there is minimal separation when the flow F encounters the splitter vane 30. Structurally the splitter vane 30 may also act as stiffener and help to strengthen diffuser pipe 20. Splitter vane (s) can thus be used to replace traditional stiffening ribs that are normally stamped on pipe wall.

The splitter vane 30 extends across the diffuser pipe 20, wall-to-wall. In the example shown in FIGS. 3 to 5, the splitter vane 30 is disposed at a lateral midpoint between opposed walls 28a and 28b, i.e. half way across the bend of the diffuser pipe 20. It is however contemplated that the splitter vane 30 could be disposed more toward the inner wall 28a of the curved portion 28, or more toward the outer wall 28b of the curved portion 28 (i.e. not centrally disposed).

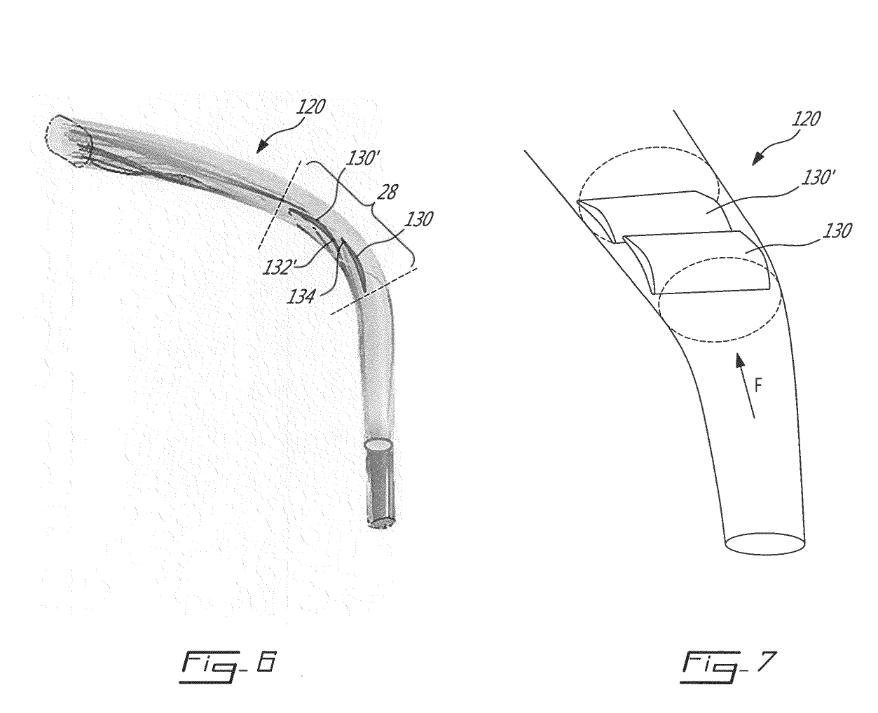

Referring now to FIGS. 6 and 7, a diffuser pipe 120 of an alternate embodiment includes within its interior flow passage two splitter vanes 130 and 130′. The diffuser pipe 120 is similar to the diffuser pipe 20, and the splitter vanes 130 and 130′ are similar to the splitter vane 30. Details of the diffuser pipe 120 and the splitter vane 130, 130′ will thus not be described in great detail herein again.

The splitter vanes 130, 130′ are disposed in a curved portion 128 of the diffuser pipe 120, with the splitter vane 130 being upstream relative to the splitter vane 130′. The curved portion 128 of the diffuser pipe 120 may be longer than the curved portion 28 of the diffuser pipe 20, in order to accommodate the multitude of splitter vanes 130, 130′. The splitter vanes 130, 130′ have a same orientation and disposition as the splitter vane 30. As best seen in FIG. 6, in this embodiment, the splitter vane 130 overlaps with a portion of the splitter vane 130′, i.e. a trailing edge 134 of the upstream splitter vane 130 is located downstream relative to a leading edge 132′ of the downstream splitter vane 130′. It is contemplated that the splitter vanes 130, 130′ could alternatively not overlap. It is also contemplated that more than two splitter vanes could be disposed in the curved portion 128. It is also contemplated that the splitter vanes 130, 130′ could have various dispositions relative to each other. For example, the splitter vanes 130, 130′ could totally overlap.

Because of the diffusion process, the diffuser pipes 20, 120 experience adverse pressure gradients in the direction of flow F, with endwall boundary layer being built up as the result. The buildup may lead to increased blockage, diminished pressure recovery and eventually lead to flow separation. The flow separation usually starts at the diffuser bend 28, 128 where the curvature is at its maximum. The splitter vane(s) 30, 130, 130′ may reduce pressure gradient across the curved portion 28, 128 and help the flow F to negotiate the tight turn more efficiently. The airfoil splitter vanes 30, 130, 130′ described herein may also facilitate swirl removal. Computational fluid models can be used to optimize the splitter vane 30, 130, 130′ length and/or location, while the inner and outer walls 28a, 28b, 128a, 128b can be shaped in accordance with the splitter vane 30, 130, 130′ to best conform to a stator pitch.

The diffuser pipes 20, 120 with splitter vane(s) 30, 130, 130′ at the curved portions 28, 128 thereof may at least reduce flow separation from initiating. Since mixing losses may be a prominent contributor to diffuser pipe loss and is initiated mostly at the curved portion 28, 128, employing splitter vane(s) 30, 130, 130′ at that location may be more effective than anywhere else in the diffuser pipe 20, 120.

One way to manufacture any of the above sheet metal diffuser pipes with internal vanes is to laser drill slots on the sheet metal forming the diffuser pipes, at a location where the splitter vane is to be disposed in the curved portion. The splitter vane(s) may then be inserted inside the diffuser pipe, for example from the outlet end O thereof, and brazed at both ends onto the inner wall(s) of the diffuser pipe where the slots are formed. Alternatively, no slots may be need to be formed and the splitter vanes may be simply brazed in place within the portion of each diffuser pipe.

The above description is meant to be exemplary only, and one skilled in the art will recognize that changes may be made to the embodiments described without departing from the scope of the invention disclosed. Other modifications which fall within the scope of the present invention will be apparent to those skilled in the art, in light of a review of this disclosure, and such modifications are intended to fall within the appended claims.

1. A compressor diffuser for a gas turbine engine, the diffuser having a plurality of diffuser pipes each comprising: a diverging tubular body defining a flow passage extending fully therethrough, the tubular body including a first portion extending in a first direction, a second portion extending in a second direction different from the first direction, and a curved portion interconnecting the first portion and the second portion; and at least one splitter vane extending into the flow passage and disposed at least partially within the curved portion of the tubular body.

2. The compressor diffuser of claim 1, wherein the second direction is generally perpendicular to the first direction.

3. The compressor diffuser of claim 1, wherein the curved portion has an inner wall and an outer wall, the splitter vane has a pressure side, a suction side, a leading edge and a trailing edge, the leading edge faces the first portion and the pressure side faces the inner wall of the curved portion.

4. The compressor diffuser of claim 1, wherein the splitter vane extends wall-to-wall across the diffuser pipe.

5. The compressor diffuser of claim 1, wherein the first portion has a generally circular cross-sectional shape, and the second portion has a generally oblong cross-sectional shape.

6. The compressor diffuser of claim 1, wherein a cross-sectional area of the diffuser pipe increases along its length from an inlet to an outlet of the diffuser pipe.

7. The compressor diffuser of claim 1, wherein the at least one splitter vane includes a first splitter vane and a second splitter vane, the second splitter vane being disposed at least partially downstream of the first splitter vane, the first splitter vane and the second splitter vane being both disposed at least partially within the curved portion.

8. The compressor diffuser of claim 7, wherein a trailing edge of the first splitter vane is disposed downstream relative to a leading edge of the second splitter vane.

9. A gas turbine engine comprising:
a centrifugal compressor including an impeller case and a plurality of diffuser pipes downstream of the impeller and receiving compressed air therefrom, each of the diffuser pipes having a diverging tubular body defining a flow passage extending therethrough, the tubular body of the diffuser pipes extending from the periphery of the impeller case and including a radial portion and an axial portion connected by a curved portion, the curved portion having at least one splitter vane disposed at least partially within the flow passage.

10. The gas turbine engine of claim 9, wherein the curved portion has an inner wall and an outer wall, the at least one splitter vane is airfoil shaped and has a pressure side, a suction side, a leading edge and a trailing edge, the leading edge faces the radial portion and the pressure side faces the inner wall of the curved portion.

11. The gas turbine engine of claim 9, wherein the radial portion extends at least partially tangentially to the periphery of the impeller.

12. The gas turbine engine of claim 9, wherein the at least one splitter vane extends wall-to-wall across the diffuser pipe.

13. The gas turbine engine of claim 9, wherein the radial portion has a generally circular cross-section, and the axial portion has a generally oblong cross-section.

14. The gas turbine engine of claim 9, wherein a cross-sectional area of the diffuser pipe increases along its length from an inlet to an outlet.

15. The gas turbine engine of claim 9, wherein the at least one splitter vane of each of the plurality of diffuser pipes includes a first splitter vane and a second splitter vane disposed at least partially in the curved portion at least partially downstream of the first splitter vane.

16. The gas turbine engine of claim 15, wherein a trailing edge of the first splitter vane is disposed downstream relative to a leading edge of the second splitter vane.

17. A method of manufacturing a diffuser pipe for a centrifugal compressor of a gas turbine engine, the method comprising:
forming a tubular body out of a sheet metal, the tubular body having a first portion extending in a first direction, a second portion extending in a second direction different from the first direction, and a curved portion between the first portion and the second portion;
inserting a splitter vane at least partially into the curved portion of the tubular body and aligning sides of the splitter vane in a desired position between opposed walls of the curved portion; and
fixing the sides of the splitter vane to the opposed walls within the curved portion.

18. The method of claim 17, further comprising forming two opposed slots in the curved portion of the tubular body at the desired location of a splitter vane before inserting the splitter vane at least partially into the curved portion.
